(19) United States
(12) Patent Application Publication
(10) Pub. No.: US 2019/0318166 A1
(43) Pub. Date: Oct. 17, 2019

(54) VR WEARABLE DEVICE AND OBSTACLE DETECTING METHOD THEREOF

(71) Applicant: PEGATRON CORPORATION, Taipei City (TW)

(72) Inventors: CHANG-SHENG TSAU, Taipei City (TW); SHEN-HAU CHANG, Taipei City (TW); CHE-MING LEE, Taipei City (TW); HSING-WEI HUANG, Taipei City (TW)

(21) Appl. No.: 16/386,753

(22) Filed: Apr. 17, 2019

(30) Foreign Application Priority Data
Apr. 17, 2018 (TW) 107113056

(51) Int. Cl. G06K 9/00; G06T 11/60; G08B 21/02

(52) U.S. Cl. CPC G06K 9/00671; G08B 21/02; G06T 11/60

(57) ABSTRACT

A virtual reality wearable device and an obstacle detecting method thereof are disclosed. The virtual reality wearable device includes an environment capture module, an image integration module, a detection module and a warning module. The environment capture module is used for capturing an external image. The image integration module is used for receiving the external image in real time as a real-time environment image, and integrating the external images captured around one circle into an initial environment image. The detection module is used for detecting whether there is a difference between the initial environment image and the real-time environment image. When there is a difference between the initial environment image and the real-time environment image, the detection module generates a notification signal. The warning module is used for sending a warning signal according to the notification signal.

### BACKGROUND

### 1. Technology Field

The present disclosure relates to a virtual reality (VR) wearable device and an obstacle detecting method thereof, and more particularly, to a VR wearable device and a method for detecting whether an obstacle appears.

### 2. Description of the Related Art

Virtual reality (VR) technology has emerged with the advancement of related techniques, VR products provide users with a simulation of the senses such as vision, so that users can feel immersive to observe objects in a three-dimensional space in timely and unrestricted. When the user moves with the virtual reality wear device, the computer can immediately perform complicated calculations to transmit accurate three-dimensional space images back to create the sense of presence. However, in prior art virtual reality wear devices, there is no such mechanism that can dynamically detect new people or objects. When a person or an object enters this restricted area, the prior art VR wear device cannot provide a warning message, and the user may hit the person or object and get injured.

Therefore, it is necessary to provide a new VR wearing device and an obstacle detecting method thereof to solve the problems of the prior art.

### SUMMARY

It is an object of the present disclosure to provide a VR wearable device, which can detect whether an obstacle appears.

It is another object of the present disclosure to provide an obstacle detecting method of the VR wearable device described above.

In order to achieve the above objects, the present disclosure discloses a virtual reality (VR) wearable device, which includes an environment capture module, an image integration module, a memory module, a detection module and a warning module. The environment capture module is used for capturing an external image. The image integration module is electrically connected to the environment capture module for receiving the external image in real time as a real-time environment image, and integrating the external images captured around one circle into an initial environment image. The detection module is electrically connected to the image integration module and the memory module for detecting whether there is a difference between the initial environment image and the real-time environment image. When there is a difference between the initial environment image and the real-time environment image, the detection module generates a notification signal. The warning module is electrically connected to the detect module for sending a warning signal according to the notification signal.

The present disclosure discloses an obstacle detecting method for a virtual reality (VR) wearable device, the method comprising the following steps: capturing an external image as a real-time environment image; integrating the external images captured around one circle into an initial environment image; detecting whether there is a difference between the initial environment image and the real-time environment image; and sending a warning signal when there is a difference between the initial environment image and the real-time environment image.

### BRIEF DESCRIPTION OF THE DRAWINGS

FIG. 1A illustrates a structural view of a VR wearable device of the present invention;

FIG. 1B illustrates a schematic view of the appearance of a first embodiment of a VR wearable device of the present invention;

FIG. 1C illustrates a schematic view of the appearance of a second embodiment of a VR wearable device of the present invention;

FIG. 2 illustrates a flow chart showing the steps of the setting process of a method for controlling the VR wearable device of the present invention;

FIG. 2A illustrates a schematic diagram of setting the VR wearable device of the present invention;

FIG. 2B illustrates a schematic diagram of an initial environment image of the present invention;

FIG. 3 illustrates a flow chart showing the steps of the determining process of the method for controlling the VR wearable device of the present invention; and

FIG. 4 illustrates a schematic diagram of a real-time environment image of the present invention.

### DETAILED DESCRIPTION OF THE PREFERRED EMBODIMENTS

In order to make the structure and characteristics as well as the effectiveness of the present invention to be further understood and recognized, the detailed description of the present invention is provided as follows along with embodiments and accompanying figures.

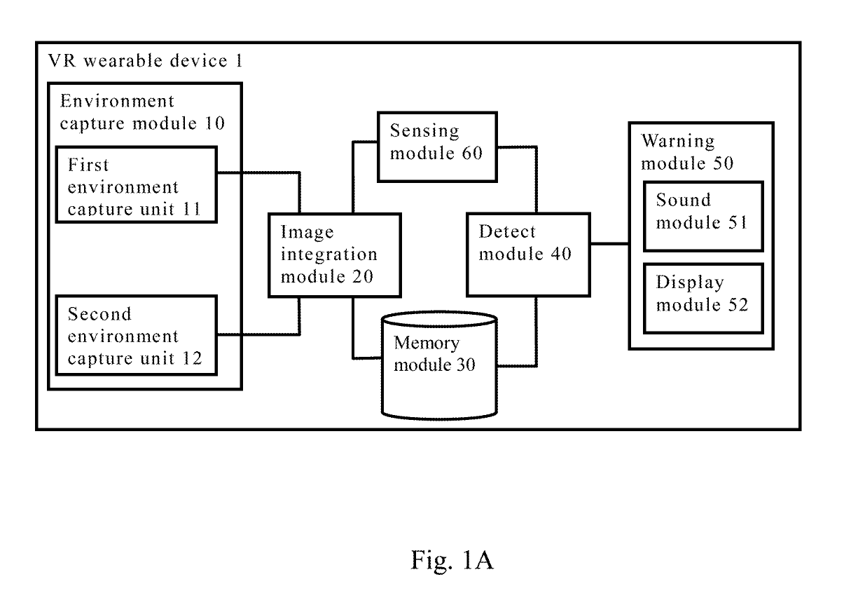

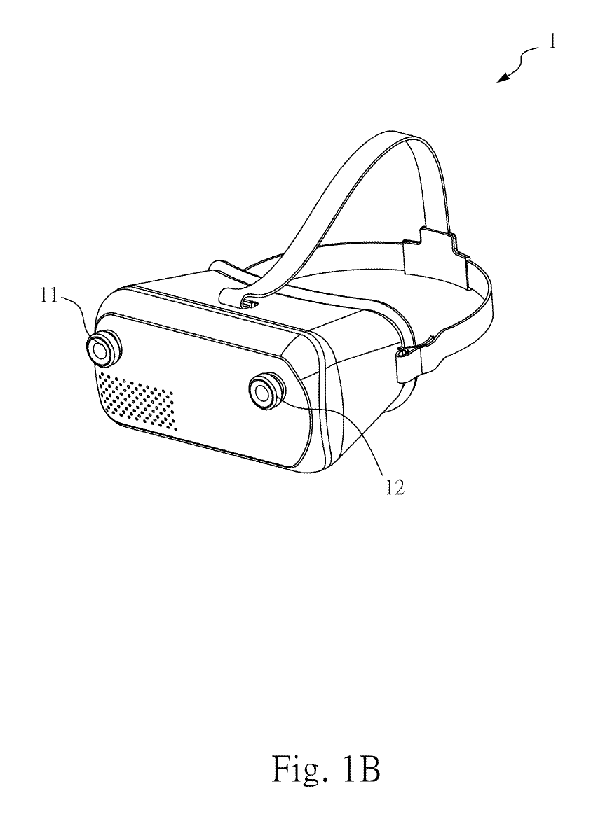

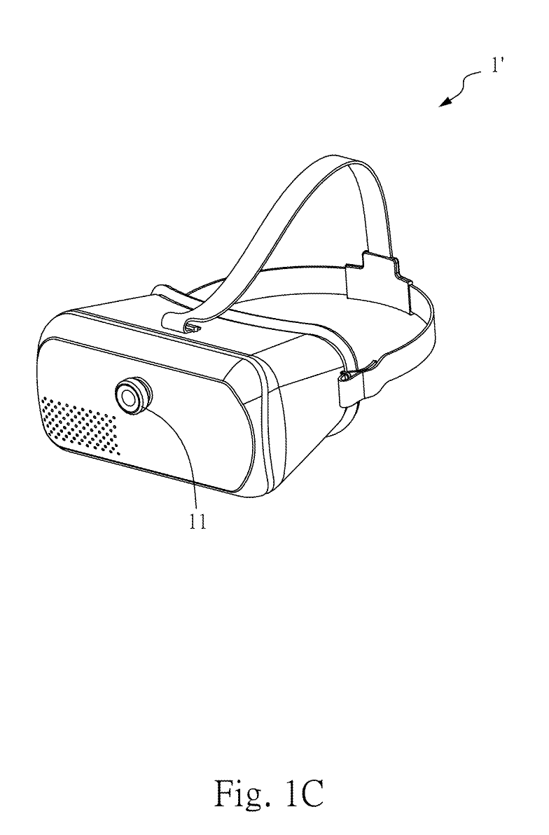

Please refer to FIG. 1A which illustrates a structural view of a VR wearable device of the present invention.

In an embodiment of the present invention, the VR wearable device 1 includes an environment capture module 10, an image integration module 20, a memory module 30, a detect module 40, a warning module 50, and a sensing module 60. As shown in FIG. 1B which illustrates a schematic view of the appearance of a first embodiment of a VR wearable device of the present invention. In the first embodiment of the present invention, the VR wearable device 1 comprises the environment capture module 10, which can include a first environment capture unit 11 and a second environment capture unit 12. The assembly angle of the first environment capture unit 11 and the second environment capture unit 12 can be greater than 110 degrees, so when the first environment capture unit 11 captures a first external image and the second environment capture unit 12 captures a second external image, the overlap region of the field of view (FOV) is approximately at the center of the VR wearable device 1, that is, on the middle line of the first environment capture unit 11 and the second environment capture unit 12. The portion of the superimposed image of the first external image and the second external image is the image directly in front of the VR wearable device 1; however, the present invention can have other implementations. Besides, as shown in FIG. 1C, which illustrates a schematic view of the appearance of a second embodiment of a VR wearable device of the present invention, the environment capture module 10 of the VR wearable device 1′ may only include a single first environment capture unit 11 for capturing the first external image.

The image integration module 20 is electrically connected to the first environment capture unit 11 and the second environment capture unit 12. In the first embodiment of the present invention, the image integration module 20 is configured to integrate the first external image and the second external image into an initial environment image during the setting process, but the present invention is not limited thereto. In the second embodiment of the present invention, the VR wearable device 1′ may have only one single first environment capturing unit, so the image integration module 20 can use only one single first external image to set the initial environment image. In the first embodiment of the present invention, the image integration module 20 determines whether the first external image and the second external image captured in real time have been repeated with the first external image and the second external image that have been captured previously. Therefore, it can be determined whether the VR wearable device 1 has been rotated for one circle to obtain the initial environment image.

Furthermore, in the first embodiment of the present invention, the image integration module 20 can integrate the first external image and the second external image obtained in real time into a single image during the determination process, which is a real-time environment image. Or in the second embodiment of the present invention, the image integration module 20 can integrate the first external image obtained in real time into a real-time environment image. The initial environment image may be a 360-degree continuous panoramic image of the VR wearable device 1, and the real-time environment image may be only the front view of the VR wearable device 1, but the invention is not limited thereto. The memory module 30 is electrically connected to the image integration module 20 for storing the initial environment image.

The detection module 40 is electrically connected to the image integration module 20 and the memory module 30 for detecting whether there is a difference between the initial environment image and the real-time environment image, when there is a difference between the initial environment image and the real-time environment image, it is determined that an obstacle may appear. Then the detection module 40 generates a notification signal. It should be noted that, in the embodiment of the present invention, the initial environment image is composed of a key frame format, wherein each key image has a plurality of key points. Therefore, the detection module 40 is used for locating key points in the real-time environment image to detect whether the number of key points of the real-time environment image is significantly reduced from the number of key points of the initial environment image, so as to know whether there is a difference between the two. In an embodiment of the present invention, when the number of key points of the real-time environment image is reduced by 5 to 10% or more from that of the initial environment image, it is considered to be significantly reduced, but the present invention is not limited thereto. In an embodiment of the present invention, the key points can be determined by the FAST (Features from Accelerated Segment Test) algorithm, and the key points of the initial environment image and the real-time environment image can be compared by the SURF. (Speed-Up Robust Feature) algorithm, but the invention is not limited thereto.

The warning module 50 is electrically connected to the detection module 40 for sending a warning signal to notify the user according to the notification signal. In the embodiment of the present invention, the warning module 50 can be a sound module 51 or a display module 52, to respectively generate an audio signal or a display signal to notify the user; furthermore, the warning module 50 can comprise the two modules at the same time, and the present invention is not limited thereto.

The VR wearable device 1 can further comprise a sensing module 60, wherein the sensing module 60 can be an electronic compass or a gyroscope to obtain a rotation angle and direction of the VR wearable device 1, but the invention is not limited thereto. Therefore, the image integration module 20 can also determine whether the VR wearable device 1 has rotated one circle according to the rotation angle and direction measured by the sensing module 60. For example, the sensing module 60 can measure whether the VR wearable device 1 has changed from a direction toward 0 degree to a direction toward 360 degrees (or back to 0 degree), and the image integration module 20 can integrate the real-time images captured from 0 degrees to 360 degrees to obtain the initial environment image. Similarly, the detection module 40 can also determine whether there is a difference between the initial environment image and the real-time environment image in the same direction according to the sensed direction obtained by the sensing module 60. Furthermore, if the VR wearable device 1 is rotated in the constant angular velocity, the number of real-time images required for the VR wearable device 1 to rotate one circle can be calculated by the degrees of angle set for capturing one real-time image. Assume that the VR wearable device 1 captures one real-time image every 5 degrees, then the VR wearable device 1 will save 360 degrees/5 degrees=72 real-time images for one circle. Therefore, when the image integration module 20 counts the 72nd real-time image, it can be determined that the VR wearable device 1 has rotated one circle. Then the image integration module 20 integrates all 72 real-time images into an initial environment image.

It should be noted that each module of the VR wearable device 1 may be a hardware device, a software program combined with a hardware device, a firmware combined with a hardware device, etc., for example, a computer program product can be stored in a computer readable medium to achieve the functions of the present invention, but the present invention is not limited thereto. In addition, the present embodiment is merely illustrative of preferred embodiments of the present invention, and in order to avoid redundancy, all possible combinations of variations are not described in detail. However, those skilled in the art will appreciate that the various modules or components described above are not necessarily required. In order to implement the invention, other well-known modules or elements in details may also be included. Each module or component may be omitted or modified as needed, and no other modules or components may exist between any two modules.

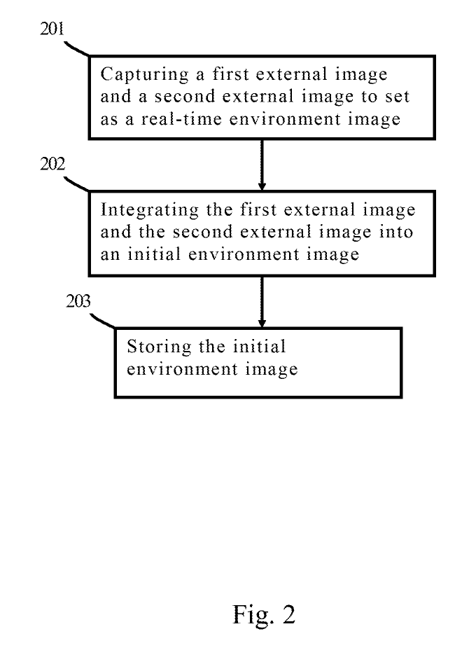

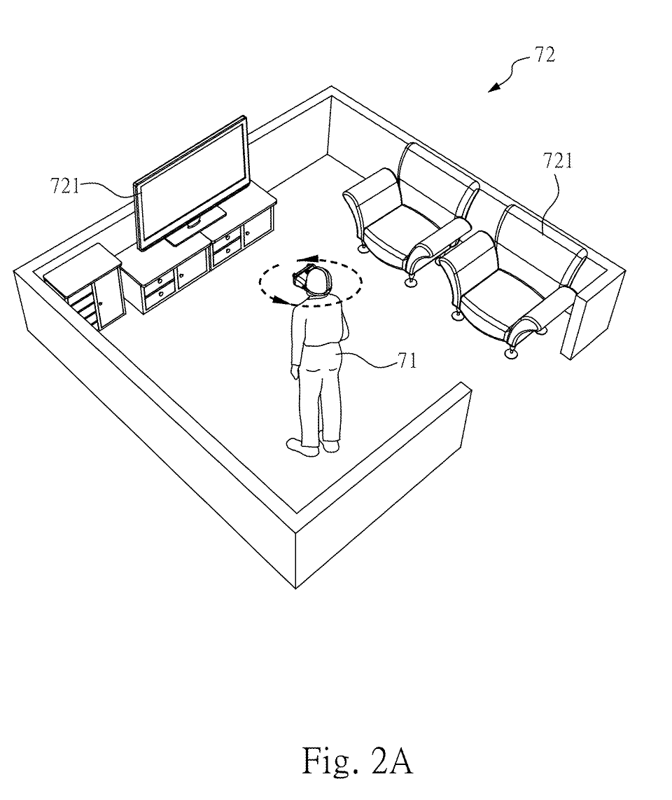

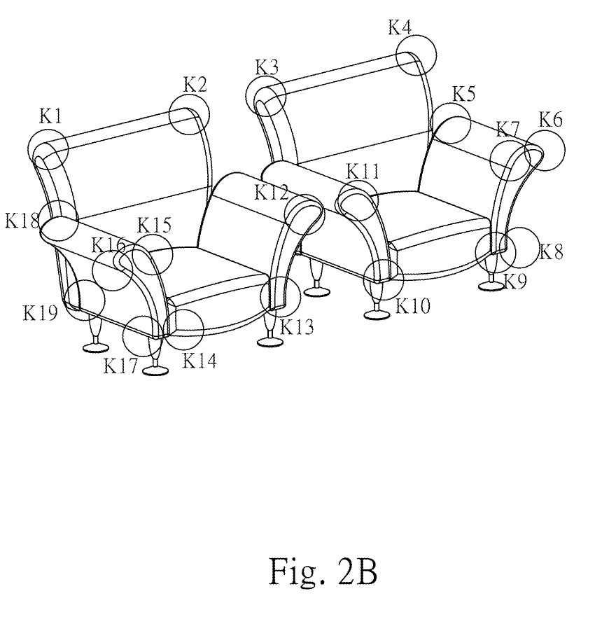

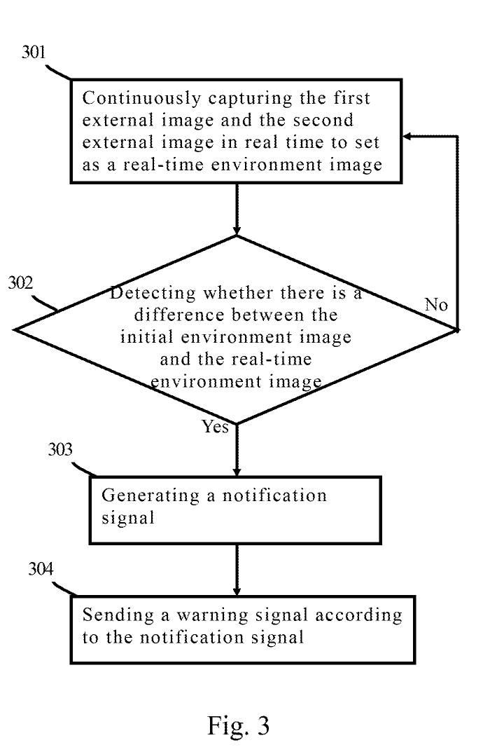

Next, please refer to FIG. 2, which illustrates a flow chart showing the steps of the setting process of a method for controlling the VR wearable device of the present invention, and FIG. 3, which illustrates a flow chart showing the steps of the determining process of the method for controlling the VR wearable device of the present invention. It should be noted that, although the VR wearable device 1 of the present invention is used as an example to describe the VR wearable device control method of the present invention, the VR wearable device control method is not limited to the use of the VR wearable device 1 of the same structure described above.

When the setting process of the VR wearable device 1 is to be performed, first the process goes to step 201: capturing a first external image and a second external image to set as a real-time environment image.

First, the first external image is captured by the first environment capture unit 11, and the second external image is captured by the second environment capture unit 12, so as to be set as the real-time environment image. The real-time environment image may be only a front-side image of the VR wearable device 1, but the invention is not limited thereto. It should be noted that in the second embodiment of the present invention, only one single environment capture unit is used for capturing a single external image. Although, the present invention is described with the first embodiment in which the first external image and the second external image may be simultaneously captured, the present invention is not limited to any number of the external images captured.

Then the process goes to step 202: integrating the first external image and the second external image into an initial environment image.

Refer to FIG. 2A, which illustrates a schematic diagram of setting the VR wearable device of the present invention. A user 71 can rotate the VR wearable device 1 for one circle in a space 72, so as to let the image integration module 20 integrate the first external image and the second external image into an initial environment image. A different object 721 can be included in the initial environment image, such as a television or a sofa shown in FIG. 2A. The image integration module 20 can determine whether the first external image and the second external image have been repeated or the direction sensed by the sensing module 60, and can also determine by counting the total number of captured images, the present invention is not limited thereto. Therefore, it can be determined whether the VR wearable device 1 has been rotated for one circle to obtain the initial environment image. Finally, an initial environment image as shown in FIG. 2B can be obtained, and FIG. 2B illustrates a partial view of the initial environment image of the present invention. The initial environment image is a key frame format, wherein different key points K1˜K19 on the object 721 can be located, but the invention is not limited thereto.

Then the process goes to step 203: storing the initial environment image.

Then the initial environment image is stored in the memory module 30, thereby finishing the setting process.

Next, please refer to FIG. 3, which illustrates a flow chart showing the steps of the determining process of the method for controlling the VR wearable device of the present invention.

When the determining process is to be performed, the image integration module 20 proceeds to step 301: continuously capturing the first external image and the second external image in real time to set as the real-time environment image.

At this time, the image integration module 20 continuously captures the first external image and the second external image in real time to set as the real-time environment image.

Then the process goes to step 302: detecting whether there is a difference between the initial environment image and the real-time environment image.

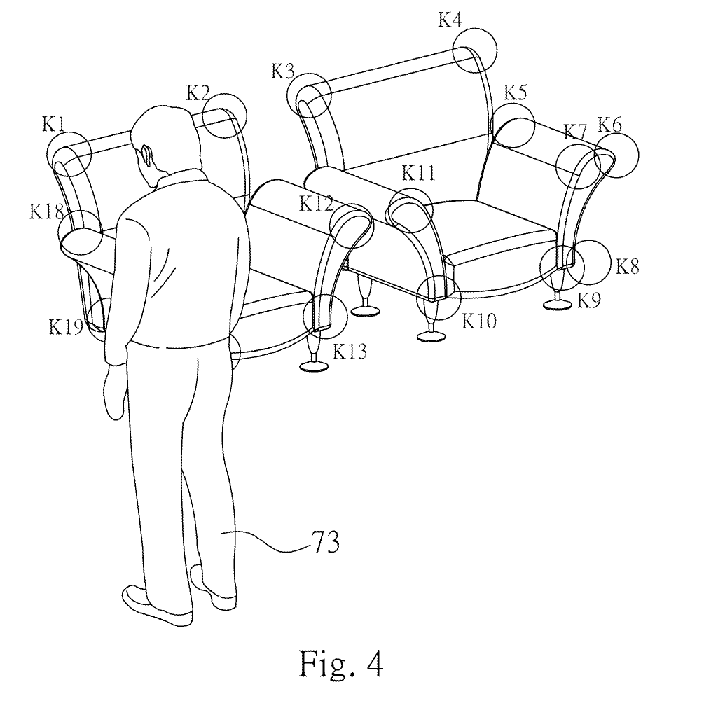

The detection module 40 is further configured to detect whether there is a difference between the initial environment image and the real-time environment. As shown in FIG. 4, FIG. 4 illustrates a schematic diagram of a real-time environment image of the present invention. When there is an obstacle 73 such as human body or other objects blocking the key images of the background, the number of key points representing the real-time environment image will be reduced. Compared with FIG. 2B, key points K14, K15, K16, K17 may be blocked by the obstacle 73 and are obviously missing in FIG. 3A. Therefore, if the detect module 40 detects that the number of key points of the real-time environment image is significantly reduced from the number of key points of the initial environment image, it is determined that there is a difference between the two. In an embodiment of the present invention, when the number of key points of the real-time environment image is reduced by 5 to 10% or more from the initial environment image, it is considered to be significantly reduced, but the present invention is not limited to this value. However, if the detection module 40 detects that there is no significant difference in the number of key points between the initial environment image and the real-time environment image, then the detection module 40 goes back to step 301.

When there is a difference between the initial environment image and the real-time environment image, the process goes to step 303: generating a notification signal.

When it is determined that there is an obstacle appearing in front of the VR wearable device 1, the detect module 40 generates a notification signal.

Finally the process goes to step 304: sending a warning signal according to the notification signal.

Finally, the warning module 50 is configured to issue a warning signal to notify the user that an obstacle 73 is ahead of the user according to the notification signal. The warning signal can be an audio signal or a display signal, or any other suitable signals.

It should be noted that the method for controlling the VR wearable device of the present invention is not limited to the above-described sequence of steps, and the order of the above steps may be changed as long as the object of the present invention can be achieved.

Therefore, the user can use the VR wearable device 1 to avoid hitting the unexpected obstacle 73.

It is noted that the above-described embodiment is merely illustrative of a preferred embodiment of the present invention, and in order to avoid redundancy, all possible combinations of variations are not described in detail. However, those skilled in the art will appreciate that the various modules or components described above are not necessarily required. In order to implement the present invention, other well-known modules or elements with more detailed functions may also be included. Each module or component may be omitted or modified as it deems necessary, and no other modules or components may exist between any two modules. As long as they do not deviate from the basic structure of the present invention, various changes and modifications may be made to the described embodiments without departing from the scope of the invention as disposed by the appended claims.

What is claimed is:

1. A virtual reality wearable device comprising:
an environment capture module for capturing an external image;
an image integration module electrically connected to the environment capture module for receiving the external image in real time as a real-time environment image, and integrating the external images captured around one circle into an initial environment image;
a memory module electrically connected to the image integration module for storing the initial environment image;
a detection module electrically connected to the image integration module and the memory module for detecting whether there is a different between the initial environment image and the real-time environment image, when there is a difference between the initial environment image and the real-time environment image, the detection module generates a notification signal; and
a warning module electrically connected to the detection module for sending a warning signal according to the notification signal.

2. The virtual reality wearable device as claimed in claim 1, wherein the environment capture module comprises a first environment capture unit for capturing a first external image; the image integration module further receives the first external image in real time to set the first external image as the real-time environment image, and integrating the first external image captured around one circle to be set as the initial environment image.

3. The virtual reality wearable device as claimed in claim 1, wherein the environment capture module comprises a first environment capture unit and a second environment capture unit for capturing a first external image and a second external image; the image integration module further receives the first external image and the second external image to integrate the first external image and the second external image into the real-time environment image, and integrating the first external image and the second external image captured around one circle to be set as the initial environment image.

4. The virtual reality wearable device as claimed in claim 3, wherein an assembly angle between the first environment capturing unit and the second environment capturing unit is greater than 110 degrees.

5. The virtual reality wearable device as claimed in claim 1 further comprising a sensing module for measuring a direction of the virtual reality wearing device, wherein the image integrating module is configured to determine whether the virtual reality wearing device has rotated one circle according to the direction to obtain the initial environment image.

6. The virtual reality wearable device as claimed in claim 1, wherein the image integration module determines whether the virtual reality wearable device has rotated one circle according to the number of external images captured to obtain the initial environment image.

7. The virtual reality wearable device as claimed in claim 1, wherein the image integration module determines whether the external image has been repeated, so as to determine whether the virtual reality wearable device has rotated one circle to obtain the initial environment image.

8. The virtual reality wearable device as claimed in claim 1, wherein the initial environment image is stored in a key frame format and has a plurality of key points, the detection module is configured to locate key points of the real-time environment image to detect the number of key points of the initial environment image and the number of key points of the real-time environment image respectively to determine whether there is a difference between the initial environment image and the real-time environment image.

9. The virtual reality wearable device as claimed in claim 8, wherein when the detect module detects that the number of key points of the real-time environment image is reduced by 5 to 10% or more from the number of key points of the initial environment image, it is determined that there is a difference between the initial environment image and the real-time environment image.

10. An obstacle detecting method for a virtual reality wearable device, the method comprising the following steps:
capturing an external image as a real-time environment image;
integrating the external images captured around one circle into an initial environment image;
detecting whether there is a difference between the initial environment image and the real-time environment image; and
sending a warning signal when there is a difference between the initial environment image and the real-time environment image.

11. The obstacle detecting method for a virtual reality wearable device as claimed in claim 10 further comprising the following step:
measuring a direction of the virtual reality wearable device, so as to determine whether the virtual reality wearable device has been rotated for one circle according to the direction to obtain the initial environment image.

12. The obstacle detecting method for a virtual reality wearable device as claimed in claim 10 further comprising the following step:
determining whether the virtual reality wearable device has rotated one circle according to the number of external images captured to obtain the initial environment image.

13. The obstacle detecting method for a virtual reality wearable device as claimed in claim 10 further comprising the following step:
determining whether the external image has been repeated, so as to determine whether the virtual reality wearable device has rotated one circle to obtain the initial environment image.

14. The obstacle detecting method for a virtual reality wearable device as claimed in claim 10, wherein the initial environment image is stored in a key frame format and has a plurality of key points, the method further comprising the following steps:
locating key points of the real-time environment image; and
detecting the number of key points of the initial environment image and the number of key points of the real-time environment image respectively to determine whether there is a difference between the initial environment image and the real-time environment image.

15. The obstacle detecting method for a virtual reality wearable device as claimed in claim 14 further comprising the following step:
when it is detected that the number of key points of the real-time environment image is reduced by 5 to 10% or more from the number of key points of the initial environment image, determining that there is difference between the initial environment image and the real-time environment image.
